(19) United States
(12) Patent Application Publication
(10) Pub. No.: US 2026/0154011 A1
(43) Pub. Date: Jun. 4, 2026

(54) SYSTEMS AND METHODS FOR A MACHINE-LEARNING BASED METHOD FOR PROCTORING ONLINE EXAMINATIONS

(71) Applicants: Constructor Technology AG, Schaffhausen (CH); Constructor Education and Research Genossenschaft, Schaffhausen (CH)

(72) Inventors: Rasilia RAKHMATULINA, Sofia (BG); Andrey ADASCHIK, Istanbul (TR); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/965,282

(22) Filed: Dec. 2, 2024

(51) Int. Cl. G06F 3/08

(52) U.S. Cl. CPC G06F 3/08

(57) ABSTRACT

Disclosed herein are systems and methods for a machine-learning based method for proctoring online examinations. In one aspect, an exemplary method includes monitoring a user taking an online examination. The method also includes detecting at least one suspicious cheating event from the user from a captured video stream or time-series telemetry data. The method further includes, in response to detecting a plurality of suspicious cheating events from the user, analyzing the detected suspicious cheating events using a trained AI proctoring model. The trained AI proctoring model is configured to: recognize a cheating pattern based on the detected plurality of suspicious cheating events, classify the cheating events based on the detected cheating pattern, and calculate a cheating risk score based on the recognized cheating patterns. The method further includes notifying a proctor of suspicious cheating by the user based on the calculated cheating risk score exceeding a predetermined threshold.

### FIELD OF TECHNOLOGY

The present disclosure relates to the field of examination proctoring, and, more specifically, to systems and methods for machine-learning based methods for proctoring and scoring online examinations.

### BACKGROUND

Examinations are now commonly taken on computers, offering convenience and accessibility for both students and institutions. These computer examinations are conducted through specialized software or platforms that allow students to take tests from remote locations. They often include features like automated proctoring, time tracking, and instant grading. However, this shift to computer examinations has also introduced new opportunities for cheating. Students might use unauthorized resources such as notes, search engines, or communication tools like messaging apps during the exam. Other students may simply have someone else pretend to be the student and take the computer examination for the student under the student's login credentials. In other cases, in examinations with video proctoring, a pre-recorded video loop of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. To counteract these tactics, some online examination platforms are increasingly using sophisticated AI, biometric verification, and more rigorous promoting techniques.

### SUMMARY

To address the shortcoming of online proctoring systems, the present disclosure describes a system and method for detecting cheating events by detecting suspicious cheating events from a user taking an online examination using time-series telemetry data, video capture of the user taking the examination, or video footage of the user. Some of the technical improvements of the present disclosure is the ability to monitor and analyze a plurality of different types of cheating events using obtained video stream of the user and capturing time-series telemetry data for the user. In addition, the present disclosure describes utilizing machine learning models to analyze the detected suspicious cheating events and calculate a cheating risk score based on recognizing cheating patterns. Furthermore, the present disclosure describes an implementation of an examination proctoring system using a webcam and the time-series telemetry data of the user taking the examination.

In one exemplary aspect, a method for proctoring online examinations is disclosed, the method including: monitoring a user taking an online examination on a computer by capturing, via a webcam, a video stream of the user taking the online examination and capturing time-series telemetry data, wherein the time-series telemetry data comprises at least one of keystrokes, mouse movements, navigation withing an exam interface, or timing anomalies; detecting at least one suspicious cheating event from the user from the video stream or the time-series telemetry data, wherein the at least one suspicious cheating event comprise at least one of a suspicious user behavior, anomalous interaction patterns, or a technical problem with the online examination; in response to detecting a plurality of suspicious cheating events from the user, analyzing the detected suspicious cheating events using a trained AI proctoring model configured to: recognize a cheating pattern based on the detected plurality of suspicious cheating events, and calculate a cheating risk score based on the recognized cheating patterns; and notifying a proctor of suspicious cheating by the user based on the calculated cheating risk score exceeding a predetermined threshold.

In some aspects, the techniques described herein relate to a method further including: classifying the cheating events based on the detected cheating pattern using the trained AI proctoring model, for a certain class of detected cheating events, performing a cheating detection test; and notifying the proctor of the suspicious cheating based on the user failing the cheating detection test.

In some aspects, the techniques described herein relate to a method, wherein the cheating detection test includes at least one of: a user face tracking test, a user gaze tracking test, an audio analysis test, a screen recording/monitoring test, a browser lockdown test, a keystroke dynamics test, or a plagiarism detection test.

In some aspects, the techniques described herein relate to a method, wherein the technical problem with the online examination includes at least one of: detecting use of a virtual camera, muting a microphone of the computer, blocking or covering the computer camera, using virtual machines on the computer, using a remote desktop software on the computer, manipulating screen sharing on the computer, recording a desktop on the computer, network disconnection or throttling on the computer, connecting an external display to the computer, manipulating system time on the computer, or manipulating a date setting on the computer.

In some aspects, the techniques described herein relate to a method, wherein detecting at least one suspicious cheating event from the user comprises: analyzing the captured video stream using a trained AI behavior classification model configured to analyze user behaviors and classify the user behavior as a suspicious cheating event or a normal test-taking event.

In some aspects, the techniques described herein relate to a method, further including: chronologically synchronizing the detected at least one suspicious cheating event across a plurality of users taking the same online examination to detect any cheating patterns corresponding to at least two users from the plurality of users working together to cheat.

In some aspects, the techniques described herein relate to a method, further including: training the AI proctoring model based on using a training dataset comprising of images or videos of known cheating events and images or videos of normal test-taking events.

In some aspects, the techniques described herein relate to a method, further including: after the online examination has completed, determining whether the user has cheated on the online examination by analyzing answers of the online examination by the user using a trained AI assessment model configured to determine whether the user has cheated based on assessment parameters, wherein the assessment parameters correspond to post-examination parameters; and calculating a final cheating risk score based on results of the trained AI proctoring model and the results of the trained assessment AI model.

In some aspects, the techniques described herein relate to a method, further including: recognizing emotional-behavioral patterns of the user for questions of the online examination by: correlating the events on a timeline to questions of the online examination, inputting the correlated events into the trained AI proctoring model, inputting the answer of the online examination by the user into the trained AI assessment model, and obtaining feedback on the questions of the online examination based on the results of the trained AI proctoring model and the trained AI assessment model.

In some aspects, the techniques described herein relate to a method, further including: training the AI assessment model based on using a training dataset comprising of data based on analyzing historical data corresponding to how users reach to and answer questions on the online examination.

According to one aspect of the disclosure, a system is provided for proctoring online examinations, the system including: at least one memory; and at least one hardware processor coupled with the at least one memory and configured, individually or in combination, to: monitor a user taking an online examination on a computer by capturing, via a webcam, a video stream of the user taking the online examination and capturing time-series telemetry data, wherein the time-series telemetry data comprises at least one of keystrokes, mouse movements, navigation withing an exam interface, or timing anomalies; detect at least one suspicious cheating event from the user from the video stream or the time-series telemetry data, wherein the at least one suspicious cheating event comprise at least one of a suspicious user behavior, anomalous interaction patterns, or a technical problem with the online examination; in response to detecting a plurality of suspicious cheating events from the user, analyze the detected suspicious cheating events using a trained AI proctoring model configured to: recognize a cheating pattern based on the detected plurality of suspicious cheating events, classify the cheating events based on the detected cheating pattern, and calculate a cheating risk score based on the recognized cheating patterns; and notify a proctor of suspicious cheating by the user based on the calculated cheating risk score exceeding a predetermined threshold.

In one exemplary aspect, a non-transitory computer-readable medium is provided storing a set of instructions thereon for proctoring online examinations, including instructions for: monitoring a user taking an online examination on a computer by capturing, via a webcam, a video stream of the user taking the online examination and capturing time-series telemetry data, wherein the time-series telemetry data comprises at least one of keystrokes, mouse movements, navigation withing an exam interface, or timing anomalies; detecting at least one suspicious cheating event from the user from the video stream or the time-series telemetry data, wherein the at least one suspicious cheating event comprise at least one of a suspicious user behavior, anomalous interaction patterns, or a technical problem with the online examination; in response to detecting a plurality of suspicious cheating events from the user, analyzing the detected suspicious cheating events using a trained AI proctoring model configured to: recognize a cheating pattern based on the detected plurality of suspicious cheating events, and calculate a cheating risk score based on the recognized cheating patterns; and notifying a proctor of suspicious cheating by the user based on the calculated cheating risk score exceeding a predetermined threshold.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for proctoring online examination according to aspects of the present disclosure.

FIG. 2 is a block diagram illustrating a system for training machine learning models to detect calculate a cheating risk score according to aspects of the present disclosure.

FIG. 3 is an example method for correlating different potential cheating events according to an aspect of the present disclosure.

FIG. 4 is an example method for proctoring online examinations by recognizing cheating patterns according to aspects of the present disclosure.

FIG. 5 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for detecting cheating of users based on pattern recognition. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

During an online examination, it is essential to ensure that test takers are not cheating. Preventing cheating in online examinations is crucial for several reasons that relate to the integrity, security, and functionality of the assessment systems. These technical considerations ensure the reliability of the online testing process and protect the infrastructure used for delivering examinations. For example, technical systems need to log and monitor user behavior during an online examination. This might involve recording patterns such as switching between browser tabs, unusual time spent on questions, or external devices being connected. Without these technical controls, it's easier for students to use external resources or collaborate without detection, leading to data that is no longer a valid reflection of their knowledge.

For online examinations to be a viable alternative to traditional in-person testing, the technology must inspire confidence among all stakeholders—students, educators, institutions, and employers. If online platforms are easily exploitable, users lose trust in the system's ability to fairly assess and safeguard exams. From a technical perspective, preventing cheating in online examinations is vital to ensure the security, reliability, and credibility of the assessment system. It protects data integrity, ensures the system's reliability, and maintains compliance with regulatory standards, all while fostering trust in the technology used. Without these technical measures, the assessment process would be vulnerable to exploitation, undermining the validity of online exams.

However, since cheating accusations are serious accusations with long lasting consequences, these systems must be certain that a user is indeed cheating before accusing the user of cheating. As an example, a user may appear to be cheating because a web cam is catching the student looking off of the display, but the user may just be looking off in the distance to think and is not actually cheating. As another example, a user may appear to be cheating by taking a long time to answer a question, but, in reality, the user is just thinking and formulating his thoughts before typing in his response. However, if a user appears to be looking off camera after answering almost every question then there is a greater probability that the user is actually cheating than a user that only occasionally looks off camera before answering a question.

Accordingly, the present disclosure detects and evaluates multiple potential cheating events throughout an online examinations for calculating a risk score of cheating. One aspect involves monitoring and detecting different types of suspicious cheating events. A second aspect involves detecting potential cheating patterns using a trained proctoring AI model. A third aspect involves inputting examination answers into a trained AI assessment model in order to generate feedback on the online examination. In addition, the present disclosure also describes various aspects of obtaining feedback from users during an online examination based on recognizing emotional-behavioral type patterns as the user is taking the online examination. In this way, a more sophisticated system for proctoring online examinations may be implemented.

Turning now to the figures, example aspects are depicted with reference to one or more components described herein, where components in dashed lines may be optional.

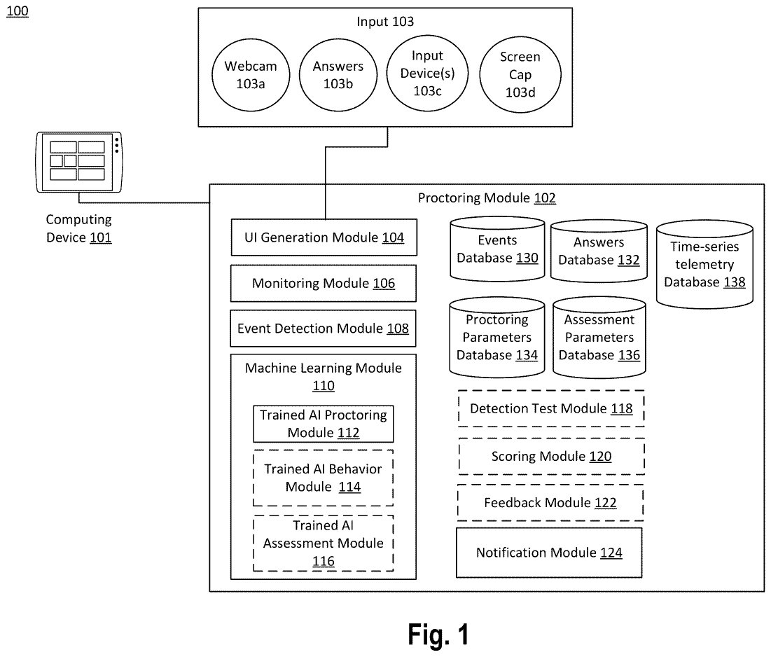

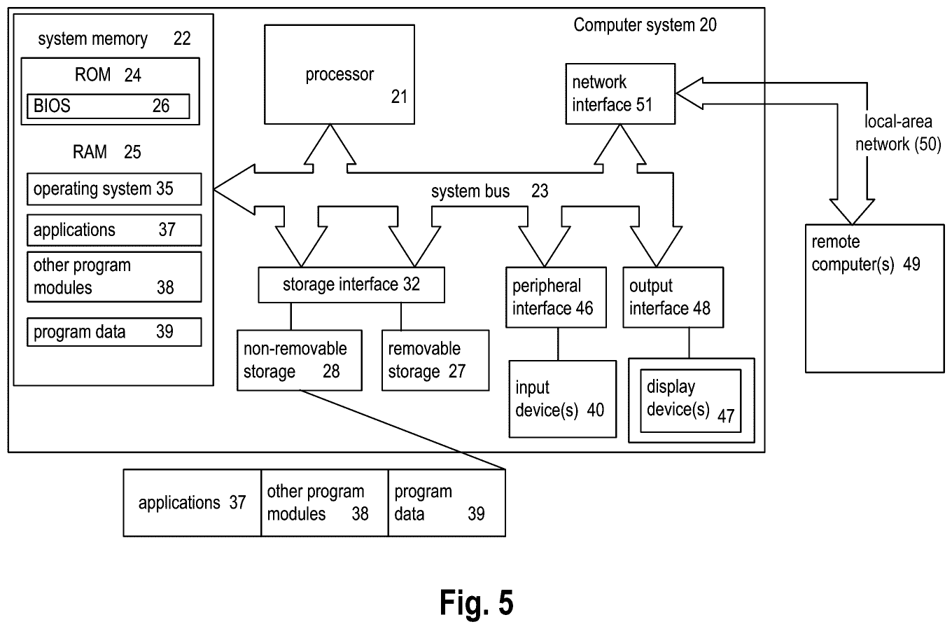

FIG. 1 is a block diagram illustrating a system 100 configured to proctor and score online examinations. In one aspect, the components of system 100 may be implemented on computer systems, such as that shown in FIG. 5.

The system 100 may be used to proctor online examinations and evaluate risks of cheating by monitoring and detecting cheating attempts. Generally, the proctoring module 102 is configured to monitor user behavior during an online examination for attempted cheating attempts and to generate a score indicating a risk assessment of the user cheating. In addition, the proctoring module 102 is optionally configured to grade the examination and obtain feedback on the online examination from a plurality of users taking the same examination. This provides a way to implement a proctoring system that detects potential cheating events, technical problems, and anomalies during the text taking process to recognize patterns and calculate score of a risk of cheating. In addition, the proctoring system may obtain and provide an emotional analysis used to obtain feedback on the online examination from different users who take the online examination.

In one aspect, the system 100 includes at least a computing device 101, inputs 103 including a webcam 103a, examination answers 103b, various input device(s) 103c, a screen capture 103d, and a proctoring module 102. The proctoring module 102 will be configured to generate a risk of cheating for a user taking the examination by monitoring and detecting cheating events and technical difficulties that arise during the online examination. In some aspects, the webcam 103a may be coupled to the computing device 101. In some aspects, the examination answers 103b will be input into the proctoring module 102 to grade the examination. In some aspects, additional input devices 103c such as heart rate monitors, smart watches, etc. may be worn by the user and telemetry data may be obtained during the examination. In some aspects, the screen of the user taking the examination may be captured in a screen capture 103d. In some aspects, a second camera may be used to capture the user taking the online examination. For example, the second camera may communicate directly with the proctoring module 102 and be mounted in a room to capture the test taking environment. As an example, the proctoring module 102 may be hosted on a cloud server or allocated at a local device (e.g., such as the computing device 101).

In some aspects, the proctoring module 102 may contain at least a UI generation module 104, a monitoring module 106, an event detection module 108, a machine learning module 110, an optional detection test module 118, an optional scoring module 120, an optional feedback module 122, and a notification module 124. The proctoring module 102 may be connected to at least an events database 130, an answers database 132, a proctoring parameters database 134, an assessment parameters database 136, and a time-series telemetry database 138. In some aspects, these databases may be hosted on the computing device 101 or a local machine. In some aspects, these databases may be hosted on a cloud server. In some aspects, the proctoring module 102 may generate a UI for display, which may be part of a client application associated with the proctoring module 102.

The computing device 101 may execute a UI generation module 104 to implement a UI for display on the computing device 101 that is configured to receive input from the computing device 101, administer the online examination to a user, and display an examination interface. In some aspects, the UI generation module 104 generates a single UI and layout and components of the UI elements (e.g., menus, buttons, forms, grids, etc.) based on predefined rules, data models, or templates. In some aspects, the UI generation module 104 may also be configured to automatically adjust the UI elements based on the content or data that it needs to display such as adapting a form to input fields or displaying a list of items. In some aspects, the UI generation module 104 may also be configured to adapt the UI to different screen sizes and resolutions by making sure that the UI works well across various devices.

The computing device 101 may execute a monitoring module 106 configured to detect and monitor for the presence of attempted cheating attempts. Specifically, the monitoring module 106 may capture visual data in the form of images or video clips, which is then processed by the proctoring module 102 for monitoring user behavior while taking an online examination on the computing device 101. In particular, the monitoring module 106 may be configured to obtain, using the webcam 103a pointed at a user taking the examination, a video stream of the user sitting in front of the computing device 101 and taking the examination. Advanced algorithms (e.g., computer vision, machine learning) are used to detect the presence of cheating attempts by recognizing suspicious user behavior, anomalous interaction patterns, or technical problem with the online examination.

In addition, the monitoring module 106 may also capture and store time-series telemetry data comprising at least one of keystrokes, mouse movements, navigation within an examination interface, or timing anomalies and store the time-series telemetry data in a time-series telemetry database 138. This module serves as the interface layer that facilitates communication between the webcam 103a, input devices 103c, screen capture 103d devices and the proctoring module 102.

The computing device 101 may execute an event detection module 108 configured to detect at least one suspicious cheating event for the user from the video stream or from the time-series telemetry data. In some aspects, the suspicious cheating event may comprise at least one of suspicious user behavior, anomalous interaction patterns, or a technical problem with the online examination. In some aspects, the technical problems may include at least one of: detecting use of a virtual camera, muting a microphone of the computer, blocking or covering the computer camera, using virtual machines on the computer, using a remote desktop software on the computer, manipulating screen sharing on the computer, recording a desktop on the computer, network disconnection or throttling on the computer, connecting an external display to the computer, manipulating system time on the computer, or manipulating a date setting on the computer. The suspicious cheating events may be stored in an events database 130 in order to log and track user behavior during the online examination.

In some aspects, the computing device 101 may execute a machine learning module 110 that includes a trained AI proctoring module 112, an optional trained AI behavior module 114, and a trained AI assessment module 116. The machine learning module 110 is trained to analyze the video of the user and time-series telemetry data to analyze detected suspicious cheating events from the user.

In some aspects, the trained AI proctoring module 112, a trained AI behavior module 114, and a trained AI assessment module 116 may contain specific trained neural network models. There are several possible approaches that may be implemented using computer vision and machine learning models such as a neural network (e.g., a convolutional neural network (CNN) and/or a recurrent neural network (RNN)). A neural network is a type of machine learning process that uses interconnected nodes or neurons in a layered structure that resembles the human brain. The neural networks create an adaptive system that computers use to learn from their mistakes and improve continuously by comprehending unstructured data and make observations without explicit training. With neural networks, computers may distinguish and recognize images similar to humans. However, the neural networks in the trained ML model for AI proctoring, AI behavior, and AI assessment must first go through training to teach the neural networks to perform their respective specific tasks.

The machine learning module 110 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 110 may be one of the following: transformer neural network, convolution neural network (CNN), recurrent neural network (RNN), long short-term memory (LSTM) network, gated recurrent unit (GRU) network, autoencoder, generative adversarial network (GAN). CNNs are effective for image-related tasks because CNNs may automatically learn spatial hierarchies of features from the input images. For videos, RNNs or Long Short-Term Memory (LSTM) networks can be used to capture temporal dependencies between frames. In some aspects, a hybrid model may be used by combining CNNs for spatial feature extraction and RNNs for temporal analysis.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

A CNN is specialized for processing grid-like data, such as images, and employs convolutional layers to learn spatial hierarchies of features, reducing the need for manual feature engineering. CNNs are well-suited for tasks like image classification, object detection, and image generation.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

For scene understanding/computer vision tasks such as recognizing a cheating pattern based on the detected plurality of suspicious cheating events, classifying the cheating events based on the detected cheating pattern, and calculating a cheating risk score based on recognizing cheating patterns, an untrained machine learning model in the trained AI proctoring module 112 will first analyze images from a training dataset to “learn” known cheating events and normal test-taking events. As an example, the training dataset may include labeled dataset containing images or videos of known cheating events and images or videos of normal test-taking events.

During training of the AI proctoring module 112, the training dataset will comprise videos or images of known cheating events and normal test-taking events that are input through an untrained neural network in the trained AI proctoring module 112. The results from the untrained machine learning models are then compared with known data set results using the corresponding cheating event or normal test taking event labels identifying events that are either suspicious cheating events or normal test taking events. It should be noted that the input to the trained AI proctoring module 112 will be images or videos from the training dataset.

For every input training sample from the training dataset, the neural network from the trained AI proctoring module 112 will produce a prediction consisting of values representing a probability that a particular detected event is a suspicious cheating event or a normal test taking event. The output with the highest probability determines the predicted suspicious cheating event or a normal test taking event. A class label for each input image is used to compute a loss (e.g., loss function).

The trained AI proctoring module 112 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks (e.g., predicting brightness levels) or a Cross-Entropy Loss for classification tasks (e.g., detecting specific color changes).

Once the neural network is trained (e.g., inference), the trained AI proctoring module 112 may recognize a cheating pattern based on the detected suspicious cheating events, classify the cheating event based on the detected cheating pattern, and calculate a cheating risk score based on the recognized cheating patterns.

During inference, the trained neural network model from the trained AI proctoring module 112 does not re-evaluate or adjust the layers of the neural network based on the results. Instead, the inference applies knowledge from the trained neural network and uses it to infer a result (e.g., recognition of a cheating pattern and/or classification of the cheating event). Accordingly, when a new unknown dataset (e.g., video stream) is input through the trained neural network in the trained AI proctoring module 112, the trained neural network outputs a prediction of the cheating pattern and what cheating event to classify the cheating pattern as based on predictive accuracy of the neural network.

Similarly, during training of the optional trained AI behavior module 114, the training dataset will comprise training dataset including at least one of: behavioral data during test-taking including at least one of mouse movement patterns, keyboard usage patterns, eye-tracking data, gaze duration/focus, and screen interaction data; environmental and device usage data including at least one of audio/video recordings of usual background noise, unusual background noise (e.g., someone else providing answers), or abnormal visual cues (e.g., using unauthorized devices or other people in the room), or screen recording or monitoring data; biometric data including at least one of facial recognition and body posture, heart rate or stress indicators (if available); contextual and situational data such as time-based data analyzing how much a user spends on each question and comparing it to the typical test-taker behavior, geolocation data, device switching data, or historical test-taking data; labeled cheating scenarios such as a dataset including various forms of simulated cheating or real-world cheating case studies; normal-test taking behaviors; proctoring feedback; or metadata and system logs. It should be noted that the input to the trained AI proctoring module 112 will be images or videos from the training dataset.

For every input training sample from the training dataset, the neural network from the trained AI behavior module 114 will produce a prediction consisting of values representing a probability that a particular detected event from the captured video stream is a suspicious cheating event or a normal test taking event. The output with the highest probability determines the predicted suspicious cheating event or a normal test taking event. A class label for each input image is used to compute a loss (e.g., loss function).

The trained AI behavior module 114 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks (e.g., predicting brightness levels) or a Cross-Entropy Loss for classification tasks (e.g., detecting specific color changes).

Once the neural network is trained (e.g., inference), the trained AI behavior module 114 may analyze user behavior and classify the user behavior as a suspicious cheating event or normal test-taking event.

During inference, the trained neural network model from the trained AI behavior module 114 does not re-evaluate or adjust the layers of the neural network based on the results. Instead, the inference applies knowledge from the trained neural network and uses it to infer a result (e.g., classify the user behavior as suspicious cheating event or a normal test-taking event). Accordingly, when a new unknown dataset (e.g., video stream) is input through the trained neural network in the trained AI behavior module 114, the trained neural network outputs a prediction of user behavior as a suspicious cheating event or a normal test-taking event.

Finally, during training of the optional trained AI assessment module 116, the training dataset will comprise training dataset including at least one of answer data including at least correctness of answers, answer similarity, pattern of answering, or content-based analysis for open-ended questions; post-examination performance analysis; statistical analysis of answer pattern; comparative analysis with other test-takers; or statistical and pattern recognition. The training dataset should contain an equal number of normal and cheating events to avoid bias during training. In addition, the training dataset should include various cheating method (e.g., collusion, access to unauthorized materials, device switching, etc.) to help the model generalize, and diverse user profiles to ensure that the dataset represents users from various backgrounds, education levels, and test types to prevent bias. By combining answer analysis, post-examination parameters, behavioral data, and statistical models, this approach can train the trained AI assessment module 116 to be capable of detecting cheating based on a range of nuanced factors. In some aspects, an optimizer such as Adam or SGD may be used to train the models in the trained AI proctoring module 112, trained AI behavior model 114 and/or the trained AI assessment module 116. In some aspects, the data may be split into training, validation, and test sets. In these aspects, the models from the trained AI proctoring module 112, trained AI behavior model 114 and/or the color trained AI assessment module 116 are trained on the training dataset and then validated by the validation sets in order to tune hyperparameters.

The computing device 101 may execute an optional detection test module 118 configured to perform a cheating detection test for a certain class of detected cheating events. In some aspects, the cheating detection test may include at least one of: a user face tracking test, a user gaze tracking test, an audio analysis test, a screen recording/monitoring test, a browser lockdown test, a keystroke dynamics test, or a plagiarism detection test. These cheating detection tests may be performed upon classification of the cheating events based on the detected cheating pattern using the trained AI proctoring model. In this way, a proctor may be notified of the suspicious cheating event abased on the user failing the particular cheating detection test.

The computing device 101 may execute an optional scoring module 120 configured to calculate a final cheating risk score based on results of the trained AI proctoring model and the results of the trained assessment AI model.

The computing device 101 may execute an optional feedback module 122 configured to recognizing emotional-behavioral patterns of the user for questions of the online examination. Specifically, the emotional-behavioral patterns can be recognized by: correlating the events on a timeline to questions of the online examination, inputting the correlated events into the trained AI proctoring model, inputting the answer of the online examination by the user into the trained AI assessment model, and obtaining feedback on the questions of the online examination based on the results of the trained AI proctoring model and the trained AI assessment model.

The computing device 101 may execute a notification module 124 configured to notifying a proctor of suspicious cheating by the user based on the calculated cheating risk score exceeding a predetermined threshold.

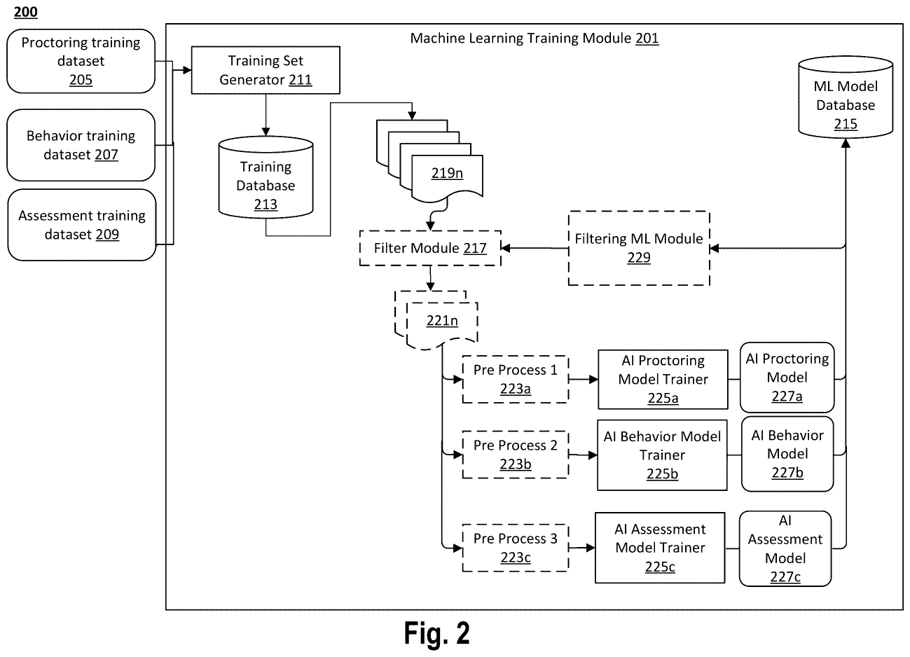

FIG. 2 is a block diagram illustrating a system training machine learning models to proctor online examinations according to aspects of the present disclosure. As shown in example 200, a ML training module 201 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained image data sets, the specialized machine learning models may perform particular tasks such as detecting changes in color parameters in videos.

Supervised learning is effective for tasks such as classification (assigning inputs to predefined categories) and regression (predicting continuous values) since it relies on the availability of labeled data for both training and evaluation phases. In supervised learning, the ML training module 201 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 201 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 201 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 201 includes at least a training database 213 configured to store the raw training data 219n and corresponding labels, a ML model database 215 to store the trained models (e.g., AI proctoring model 227a, AI behavior model 227b, and/or AI assessment model 227c). In some aspects, the ML training module 201 may include an optional filtering machine learning model 229 and a filter module 217 configured to filter data from the training database 213 for training by removing poorly generated training data.

Training data from the proctoring training dataset 205, behavior training dataset 207, and assessment training dataset 209 is received into the ML training module 201 via the training set generator 211. In some aspects, the proctoring model training dataset 205 comprises at least images of known cheating events and normal test-taking events. The behavior training dataset 207 comprises at least images of known cheating behavior and normal test-taking behavior. The assessment training dataset 209 comprises at least data based on analyzing historical data corresponding to how users react to and answer questions on the online examination. More specifics of the data included in each training dataset is described in more detail above with FIG. 1.

An optional filter module 229 is configured to filter out bad training images and/or data in order to clean up the training data in the training dataset 219n. In some examples, the filter module 217 may be a neural network. In some examples, the filter module 217 is a mathematical model. In some examples, the cleaned training dataset 221n then undergoes optional preprocessing steps depending on which neural network or model is being trained.

The optional preprocess 1 223a, preprocess 2 223b, and preprocess 3 223c are automated processes that modify the raw data received from 219n (or cleaned training dataset 221n) and prepare the raw data as input to the respective model trainers (e.g., AI proctoring model trainer 225a, AI behavior model trainer 225b, or AI assessment model trainer 225c). These may be described in the ML training module 201 as snippets of code that prepares the datasets. In some examples, the preprocessing module (e.g., preprocess 1 223a, preprocess 2 223b, and preprocess 3 223c) for a particular trainer may be an automated script or code that will be setup the first time any model is trained.

The AI proctoring model trainer 225a, AI behavior model trainer 225b, or AI assessment model trainer 225c are the scripts or code that train the respective models. The AI proctoring model trainer 225a, AI behavior model trainer 225b, or AI assessment model trainer 225c may be a script or code that holds the instructions on how a model should be trained (e.g., optimization method, model architecture, dataset division, etc.) and also runs the training. The AI proctoring model trainer 225a, AI behavior model trainer 225b, or AI assessment model trainer 225c each take as input the raw or filtered processed training data and train the AI proctoring model trainer 225a, AI behavior model trainer 225b, or AI assessment model trainer 225c to achieve their specific objectives, respectively.

In summary, the raw dataset 219 or cleaned dataset 221n may optionally go through different preprocessing steps 223a, 223b, 223c and then a corresponding AI proctoring model trainer 225a, AI behavior model trainer 225b, or AI assessment model trainer 225c to generate a trained AI proctoring model 227a, AI behavior model 227b, and AI assessment model 227c. In some examples, each of these models may be a neural network.

As a non-limiting example and as discussed above, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training images from the training database 213. Accordingly, to create a clean and filtered training dataset, the filter module 217 is configured to filter out unwanted data points from the raw training dataset 219n by developing smaller, less accurate systems based on patterns and metadata information.

During the training process, the AI proctoring model trainer 225a, AI behavior model trainer 225b, or AI assessment model trainer 225c (e.g., neural networks) are presented with input data and labels of actual values, and the optimization objective, which aims to minimize the difference between the actual value and the predicted value, is calculated. The optimization algorithm updates the parameters of the AI proctoring model trainer 225a, AI behavior model trainer 225b, or AI assessment model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., AI proctoring model trainer 225a, AI behavior model trainer 225b, or AI assessment model trainer 225c) is created, and a new process for filtering and automated labeling is established, it is added to the ML model database 215 in the ML training module 201. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a mathematical model. This approach may capture changes in the data over time.

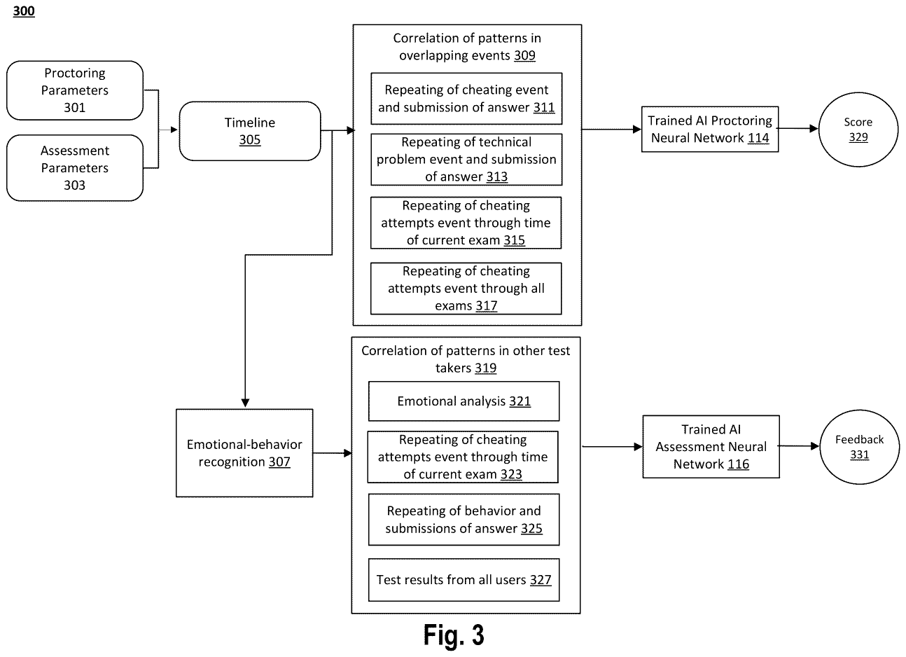

FIG. 3 is an example method for correlating different potential cheating events according to an aspect of the present disclosure.

As shown in example 300 of FIG. 3, proctoring parameters 301 and assessment parameters 303 may be plotted on a timeline 305 to chronologically synchronize the detected at least one suspicious cheating event across a plurality of users taking a same online examination to detect any cheating patterns corresponding to at least two users from a plurality of users working together to cheat. In some aspects, the proctoring parameters 301 may include at least one of violations, relative time from start, screenshot captures, video captures, cheating events, technical problems, soft activation, brightness, or gaze tracking. In some aspects, the assessment parameters 303 may include at least one of quantity of questions, correctness of each answer, time for answer, time for answering each question, keyboard input characteristics, or historical data of user cheating.

In this way, the timeline 305 helps determine a correlation of patterns in overlapping events 309. The patterns may include at least: repeating of cheating event and submission of answer 311, repeating of technical problem event and submission of answer 313, repeating of cheating attempt through time of current exam 315, or repeating of cheating attempts event through all exams 317. The principle behind this is that a single isolated event may not be considered suspicious, but if the event is repeated or occurs at a single time amongst multiple users, then the event may be flagged as a suspicious cheating event. The trained AI proctoring module 114 (e.g., trained AI proctoring module 114 shown in FIG. 1) then calculates and generates a cheating risk score 329 based on the recognized cheating patterns.

In addition, the timeline 305 also helps track patterns in emotional-behavior recognition 307 by determining a correlation of patterns in other test takers 319. The patterns may include emotional analysis 321, repeating of cheating attempts through time of current examination 323, repeating of behaviors and submissions of answers 325, and test results from all users 327. The correlated events and answers of the online examination are input into the trained AI assessment model for grading and obtaining feedback 331 on the questions of the online examination using emotional-behavioral patterns detected from the timeline 305. As an example, this may include determining that a particular question was very difficult even though a majority of students answered it correctly due to the students taking a lot of time to answer the questions or captured videos indicating that the students were exhibiting stress while answering the particular question.

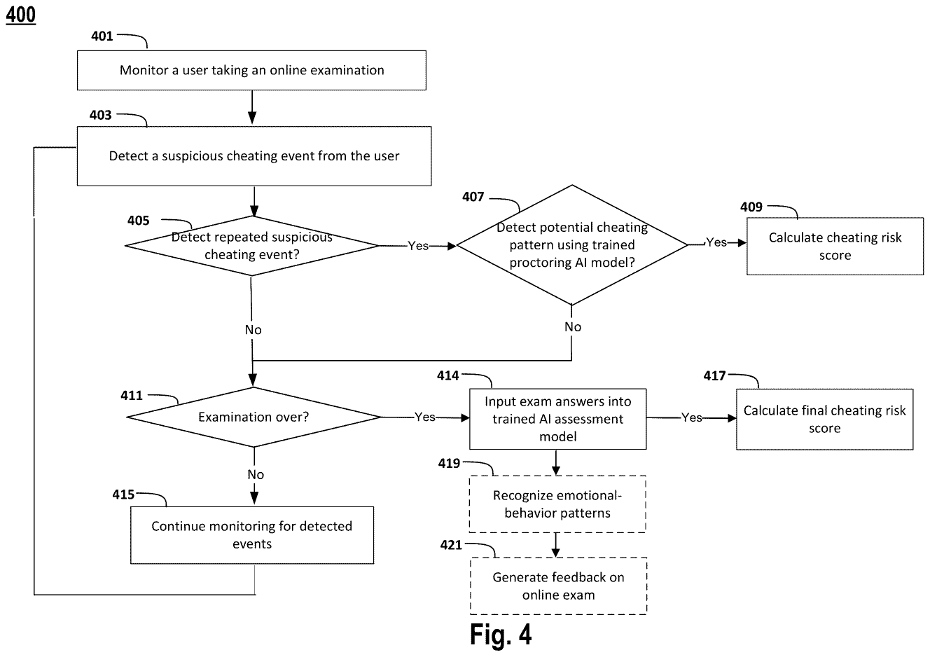

FIG. 4 is an example method for proctoring online examinations by recognizing cheating patterns according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method for implementing a system for proctoring online examinations.

At 401, the method 400 includes monitoring a user taking an online examination on a computer by capturing, via a webcam, a video stream of the user taking the online examination and capturing time-series telemetry data or other interaction patterns indicative of irregular behavior including at least one of keystrokes, mouse movements, navigation within an examination interface, or timing anomalies. In some aspects, the screen of the user may be recorded. In some aspects, video from a second camera may also be used to monitor the user taking the examination.

At 403, the method 400 includes detecting least one suspicious cheating event from the user from the video stream or the time-series telemetry data. The at least one suspicious cheating event comprise at least one of a suspicious user behavior, anomalous interaction patterns, or a technical problem with the online examination. In some aspects, suspicious event may also be detected from the timeline of passing the examination.

In some aspects, detecting at least one suspicious cheating event from the user comprises: analyzing the captured video stream using a trained AI behavior classification model configured to analyze user behaviors and classify the user behavior as a suspicious cheating event or a normal test-taking event.

In some aspects, the method 400 may include chronologically synchronizing the detected at least one suspicious cheating event across a plurality of users taking the same online examination to detect any cheating patterns corresponding to at least two users from the plurality of users working together to cheat.

In some aspects, the technical problem with the online examination comprises at least one of: detecting use of a virtual camera, muting a microphone of the computer, blocking or covering the computer camera, using virtual machines on the computer, using a remote desktop software on the computer, manipulating screen sharing on the computer, recording a desktop on the computer, network disconnection or throttling on the computer, connecting an external display to the computer, manipulating system time on the computer, or manipulating a date setting on the computer.

At 405, the method 400 includes determining whether a repeated suspicious cheating event has been detected. Based on a determination that a repeated suspicious cheating event has been detected, then, at 407, the method 400 includes detecting potential cheating pattern using a trained proctoring AI model. Based on a determination that a potential cheating pattern has been detected using the trained proctoring AI model, then, at 409, the method 400 includes calculating a cheating risk score based on the recognized cheating patterns.

In some aspects, the method 400 includes classifying the cheating events based on the detected cheating pattern using the trained AI proctoring model. The method 400 also includes for a certain class of detected cheating events, performing a cheating detection test. The method 400 further includes notifying the proctor of the suspicious cheating based on the user failing the cheating detection test. In some aspects, the cheating detection test comprises at least one of: a user face tracking test, a user gaze tracking test, an audio analysis test, a screen recording/monitoring test, a browser lockdown test, a keystroke dynamics test, or a plagiarism detection test.

In some aspects, the method 400 includes training the AI proctoring model based on using a training dataset comprising of images or videos of known cheating events and images or videos of normal test-taking events.

In some aspects, the method 400 includes notifying a proctor of suspicious cheating by the user based on the calculated cheating risk score exceeding a predetermined threshold.

Based on a determination that a repeated suspicious cheating event has not been detected, at 411, the method 400 includes determining whether the examination is over.

Based on a determination that the examination is not over, then, at 415, the method 400 includes continuing to monitor for detected events and the method 400 goes back to 403.

Based on a determination that the examination is over then, at 414, the method 400 includes inputting examination answers into a trained AI assessment model. In some aspects, the method 400 includes: after the online examination has completed, determining whether the user has cheated on the online examination by analyzing answers of the online examination by the user using a trained AI assessment model configured to determine whether the user has cheated based on assessment parameters. In some aspects, the method 400 includes: determining whether the user has cheated on the online examination by analyzing answers of the online examination by the user using a trained AI assessment model configured to determine whether the user has cheated based on assessment parameters. The assessment parameters correspond to post-examination parameters. In some aspects, the assessment parameters correspond to at least one of: correctness of answer, similarity of answers to another user, time for answering a question or historical data of user cheating.

In some aspects, the method 400 may include training the AI assessment model based on using a training dataset comprising of data based on analyzing historical data corresponding to how users react to and answer questions on the online examination.

At 417, the method 400 includes calculating a final cheating risk score based on results of the trained AI proctoring model and the results of the trained assessment AI model.

It is understood that the method illustrated by FIG. 4 are exemplary in nature and that the steps described herein may be combined to generate alternative embodiments.

Optionally, at 419, the method 400 includes recognizing emotional-behavior patterns. In some aspects, recognizing emotional-behavioral patterns of the user for questions of the online examination by correlating the events on a timeline to questions of the online examination, inputting the correlated events into the trained AI proctoring model, inputting the answer of the online examination by the user into the trained AI assessment model, and obtaining feedback on the questions of the online examination based on the results of the trained AI proctoring model and the trained AI assessment model. Optionally, at 421, the method 400 includes generating feedback on the online examination.

FIG. 5 is a block diagram illustrating a computer system 20 on which aspects of systems and methods for an online examination proctoring system may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A machine-learning based method for proctoring online examinations, the method comprising:
monitoring a user taking an online examination on a computer by capturing, via a webcam, a video stream of the user taking the online examination and capturing time-series telemetry data, wherein the time-series telemetry data comprises at least one of keystrokes, mouse movements, navigation withing an examination interface, or timing anomalies
detecting at least one suspicious cheating event from the user from the video stream or the time-series telemetry data, wherein the at least one suspicious cheating event comprise at least one of a suspicious user behavior, anomalous interaction patterns, or a technical problem with the online examination;
in response to detecting a plurality of suspicious cheating events from the user, analyzing the detected suspicious cheating events using a trained AI proctoring model configured to:
recognize a cheating pattern based on the detected plurality of suspicious cheating events, and
calculate a cheating risk score based on the recognized cheating patterns; and
notifying a proctor of suspicious cheating by the user based on the calculated cheating risk score exceeding a predetermined threshold.

2. The method of claim 1, further comprising:
classifying the cheating events based on the detected cheating pattern using the trained AI proctoring model;
for a certain class of detected cheating events, performing a cheating detection test; and
notifying the proctor of the suspicious cheating based on the user failing the cheating detection test.

3. The method of claim 2, wherein the cheating detection test comprises at least one of: a user face tracking test, a user gaze tracking test, an audio analysis test, a screen recording/monitoring test, a browser lockdown test, a keystroke dynamics test, or a plagiarism detection test.

4. The method of claim 1, wherein the technical problem with the online examination comprises at least one of: detecting use of a virtual camera, muting a microphone of the computer, blocking or covering the computer camera, using virtual machines on the computer, using a remote desktop software on the computer, manipulating screen sharing on the computer, recording a desktop on the computer, network disconnection or throttling on the computer, connecting an external display to the computer, manipulating system time on the computer, or manipulating a date setting on the computer.

5. The method of claim 1, wherein detecting at least one suspicious cheating event from the user comprises:
analyzing the captured video stream using a trained AI behavior classification model configured to analyze user behaviors and classify the user behavior as a suspicious cheating event or a normal test-taking event.

6. The method of claim 1, further comprising:
chronologically synchronizing the detected at least one suspicious cheating event across a plurality of users taking the same online examination to detect any cheating patterns corresponding to at least two users from the plurality of users working together to cheat.

7. The method of claim 1, further comprising:
training the AI proctoring model based on using a training dataset comprising of images or videos of known cheating events and images or videos of normal test-taking events.

8. The method of claim 1, further comprising:
after the online examination has completed, determining whether the user has cheated on the online examination by analyzing answers of the online examination by the user using a trained AI assessment model configured to determine whether the user has cheated based on assessment parameters, wherein the assessment parameters correspond to post-examination parameters; and
calculating a final cheating risk score based on results of the trained AI proctoring model and the results of the trained assessment AI model.

9. The method of claim 8, further comprising:
recognizing emotional-behavioral patterns of the user for questions of the online examination by:
correlating the events on a timeline to questions of the online examination,
inputting the correlated events into the trained AI proctoring model,
inputting the answer of the online examination by the user into the trained AI assessment model, and
obtaining feedback on the questions of the online examination based on the results of the trained AI proctoring model and the trained AI assessment model.

10. The method of claim 8, wherein the assessment parameters correspond to at least one of: correctness of answer, similarity of answers to another user, time for answering a question, or historical data of user cheating.

11. The method of claim 8, further comprising:
training the AI assessment model based on using a training dataset comprising of data based on analyzing historical data corresponding to how users react to and answer questions on the online examination.

12. A system for proctoring online examinations, the system comprising:
at least one memory; and
at least one hardware processor coupled with the at least one memory and configured, individually or in combination, to:
monitor a user taking an online examination on a computer by capturing, via a webcam, a video stream of the user taking the online examination and capturing time-series telemetry data, wherein the time-series telemetry data comprises at least one of keystrokes, mouse movements, navigation withing an exam interface, or timing anomalies;
detect at least one suspicious cheating event from the user from the video stream or the time-series telemetry data, wherein the at least one suspicious cheating event comprise at least one of a suspicious user behavior, anomalous interaction patterns, or a technical problem with the online examination;
in response to detecting a plurality of suspicious cheating events from the user, analyze the detected suspicious cheating events using a trained AI proctoring model configured to:
recognize a cheating pattern based on the detected plurality of suspicious cheating events, and
calculate a cheating risk score based on the recognized cheating patterns; and
notify a proctor of suspicious cheating by the user based on the calculated cheating risk score exceeding a predetermined threshold.

13. The system of claim 12, wherein the at least one hardware processor is configured to:
classifying the cheating events based on the detected cheating pattern using the trained AI proctoring model;
for a certain class of detected cheating events, performing a cheating detection test; and
notifying the proctor of the suspicious cheating based on the user failing the cheating detection test.

14. The system of claim 13, wherein the cheating detection test comprises at least one of: a user face tracking test, a user gaze tracking test, an audio analysis test, a screen recording/monitoring test, a browser lockdown test, a keystroke dynamics test, or a plagiarism detection test.

15. The system of claim 12, wherein the technical problem with the online examination comprises at least one of: detecting use of a virtual camera, muting a microphone of the computer, blocking or covering the computer camera, using virtual machines on the computer, using a remote desktop software on the computer, manipulating screen sharing on the computer, recording a desktop on the computer, network disconnection or throttling on the computer, connecting an external display to the computer, manipulating system time on the computer, or manipulating a date setting on the computer.

16. The system of claim 12, wherein detecting at least one suspicious cheating event from the user comprises:
analyzing the captured video stream using a trained AI behavior classification model configured to analyze user behaviors and classify the user behavior as a suspicious cheating event or a normal test-taking event.

17. The system of claim 12, wherein the at least one hardware processor is configured to:
chronologically synchronizing the detected at least one suspicious cheating event across a plurality of users taking the same online examination to detect any cheating patterns corresponding to at least two users from the plurality of users working together to cheat.

18. The system of claim 12, wherein the at least one hardware processor is configured to: training the AI proctoring model based on using a training dataset comprising of images or videos of known cheating events and images or videos of normal test-taking events.

19. The system of claim 12, wherein the at least one hardware processor is configured to:
after the online examination has completed, determining whether the user has cheated on the online examination by analyzing answers of the online examination by the user using a trained AI assessment model configured to determine whether the user has cheated based on assessment parameters, wherein the assessment parameters correspond to post-examination parameters; and
calculating a final cheating risk score based on results of the trained AI proctoring model and the results of the trained assessment AI model.

20. A non-transitory computer readable medium storing thereon computer executable instructions for proctoring online examinations, including instructions for:
monitoring a user taking an online examination on a computer by capturing, via a webcam, a video stream of the user taking the online examination and capturing time-series telemetry data, wherein the time-series telemetry data comprises at least one of keystrokes, mouse movements, navigation withing an exam interface, or timing anomalies;
detecting at least one suspicious cheating event from the user from the video stream or the time-series telemetry data, wherein the at least one suspicious cheating event comprise at least one of a suspicious user behavior, anomalous interaction patterns, or a technical problem with the online examination;
in response to detecting a plurality of suspicious cheating events from the user, analyzing the detected suspicious cheating events using a trained AI proctoring model configured to:
recognize a cheating pattern based on the detected plurality of suspicious cheating events, and
calculate a cheating risk score based on the recognized cheating patterns; and
notifying a proctor of suspicious cheating by the user based on the calculated cheating risk score exceeding a predetermined threshold.
